(19) United States
(12) Patent Application Publication
(10) Pub. No.: US 2025/0320325 A1
(43) Pub. Date: Oct. 16, 2025

(54) VITRIMERIZATION OF THERMOSETS CONTAINING CARBONATE AND/OR THIOURETHANE LINKAGES

(71) Applicant: CASE WESTERN RESERVE UNIVERSITY, Cleveland, OH (US)

(72) Inventors: Ica Manas-Zloczower, Pepper Pike, OH (US); Rasoul Rahimzadeh, Cleveland, OH (US); Yazhe Han, Cleveland, OH (US)

(21) Appl. No.: 19/250,266

(22) Filed: Jun. 26, 2025

Related U.S. Application Data
(60) Provisional application No. 63/597,795, filed on Nov. 10, 2023.

(51) Int. Cl. C08G 18/44; C08G 18/38; C08J 11/16

(52) U.S. Cl. CPC C08G 18/44; C08G 18/3868; C08J 11/16; C08J 2300/24

(57) ABSTRACT

A recyclable thermoset includes a mechanochemically vitrimerized polythiourethane, or polycarbonate that includes a dynamic recyclable network in which a portion of a catalyst complexes thiourethane groups of the polythiourethane or carbonate groups of the polycarbonate in the presence of a hydroxyl-providing agent.

### RELATED APPLICATION

This application claims priority from U.S. Provisional Application No. 63/664,249, filed Jun. 26, 2024, the subject matter of which is incorporated herein by reference in its entirety.

### BACKGROUND

Thermoset polymers show excellent thermal stability, chemical resistance and thermomechanical properties, making them widely used in a range of applications such as construction, coatings, adhesives, biomaterials, optics and electrical equipment. Poly allyl diglycol carbonate (PADC) and polythiourethane (PTU) are thermoset polymers with chemical structures containing carbonate and thiourethane linkages, respectively, displaying unique properties such as optical clarity and impact resistance. Their applications span from eyeglass and photo lenses, bulletproof windows, optical instruments, and neutron dosimetry to medical devices and adhesives, making them versatile materials for different industrial needs. However, their non-recyclable nature leads to environmental issues, such as waste buildup and contamination. To address these challenges, researchers have turned to vitrimer-type polymers, based on covalent adaptable networks. Vitrimers, containing dynamic covalent bonds, allow reshaping and recycling while maintaining thermoset-like properties, thus in alignment with the principles of a circular economy.

There are a number of studies looking at vitrimers containing carbonate or thiourethane functional groups. For instance, a Ti(IV) alkoxide catalyst was used for the synthesis of a crosslinked polycarbonate network containing pendant hydroxyl groups showing carbonate exchange reaction at elevated temperature, thus a vitrimer-like behavior. A PTU network was synthesized containing excess thiol groups in the presence of triphenylphosphine (PPh3) as a catalyst for the exchange reaction. The resulting PTU vitrimer exhibits full recovery of cross-link density after multiple elevated-temperature reprocessing cycles. In recent studies, alternative catalysts, such as dibutyl tin dilaurate, tetraphenylborate salts, isopropyl methane sulfonate and lanthanide triflates were employed to create PTUs with vitrimer-like properties. Development of new vitrimers is a protective approach to reduce future thermoset waste but it does not tackle the problem of the existing thermoset waste.

### SUMMARY

This disclosure describes a method of recycling thermosets containing carbonate and/or thiourethane linkages, such as polyallyl diglycol carbonate (PADC) and polythiourethane (PTU), commonly used in commercial applications via a mechanochemical process known as vitrimerization. The method utilizes zinc-based catalysts along with a hydroxyl (OH)-providing agent to make a covalent adaptable network. The results show that the permanent crosslinked structure of the thermoset containing carbonate and/or thiourethane linkages is converted to a dynamic network upon vitrimerization. Rheological tests revealed the remarkable stress-relaxation capabilities of the vitrimerized networks, indicating the conversion of the initial permanent crosslinked structures into dynamic networks through vitrimerization. Dynamic mechanical analysis results show that the vitrimerized samples display a consistent rubbery plateau at high temperature, similar to that of permanently crosslinked networks, suggesting a fixed crosslink density during an exchange reaction. Differential scanning calorimetry and thermogravimetric analysis results showed that the thermal properties of the vitrimerized samples closely resemble those of the original samples. Advantageously, the processing conditions do not require the handling or use of solvents, thereby representing a significant improvement over approaches in which catalysts are dissolved in a solution so as to induce swelling of the thermoset and expedite the overall recycling process.

In some embodiments, a method of recycling a thermoset containing a thiourethane linkage and/or a carbonate linkage can include mechanically mixing the thermoset with a catalyst and a hydroxyl providing agent such that a portion of the catalyst complexes carbonate groups and/or thiourethane groups of the thermoset. The mixture can then be thermally processed to form a recyclable thermoset that includes a dynamic recyclable network.

In some embodiments, the thermoset can be provided as particles and/or fragments, preferably, particles and/or fragments having an average diameter less than about 1 mm, more preferably, less than about 500 μm. The particles and/or fragments can be formed by mechanically grinding the thermoset.

In some embodiments, the catalyst is provided at about 5.0 wt. % to about 10 wt. % of the mechanically mixed thermoset.

In some embodiments, the catalyst can include a zinc-based catalyst, such as zinc acetate or zinc acetylacetonate.

In some embodiments, the thermoset is a polycarbonate, and the zinc-based catalyst is zinc acetylacetonate.

In other embodiments, the thermoset is a polythiourethane, and the zinc-based catalyst is zinc acetate.

In some embodiments, the hydroxyl-providing agent is a polyol, such as pentaerythritol, dipentaerylthritol, or tripentaerythritol.

In some embodiments, the mixture is mechanically mixed by milling, preferably, ball milling, more preferably, cryomilling.

In some embodiments, the mixture is thermally processed at a temperature of about 170° C. to about 200° C. and at a pressure of about 1 MPa to about 10 MPa.

Other embodiments relate to a method for producing a recyclable polycarbonate or a recyclable polythiourethane. The method includes mechanically mixing a thermoset polycarbonate or a thermoset polythiourethane with a catalyst and a hydroxyl-providing agent. The mixture is thermally processed to form a recyclable vitrimer polythiourethane or a recyclable vitrimer polycarbonate that includes a dynamic recyclable network in which a portion of the catalyst complexes carbonate groups of the polycarbonate or thiourethane groups of the polyurethane.

In some embodiments, the thermoset polycarbonate or the thermoset polythiourethane are provided as particles and/or fragments, preferably, particles and/or fragments having an average diameter less than about 1 mm, more preferably, less than about 500 μm.

In some embodiments, the thermoset polycarbonate or the thermoset polythiourethane are mechanically ground to provide the particles and/or fragments.

In some embodiments, the catalyst is provided at about 5.0 wt. % to about 10 wt. % of the mechanically mixed thermoset polycarbonate or thermoset polythiourethane.

In some embodiments, the catalyst can include a zinc-based catalyst, such as zinc acetate or zinc acetylacetonate. For example, the thermoset polycarbonate can be mechanically mixed with zinc acetylacetonate, and the thermoset polythiourethane can be mechanically mixed with zinc acetate.

In some embodiments, the hydroxyl providing agent is a polyol, such as pentaerythritol, dipentaerylthritol, or tripentaerythritol.

In some embodiments, the mixture is mechanically mixed by milling, preferably, ball milling, more preferably, cryomilling.

In some embodiments, the mixture is thermally processed at a temperature of about 170° C. to about 200° C. and at a pressure of about 1 MPa to about 10 MPa.

Other embodiments relate to recycled thermoset polycarbonate or recycled thermoset polythiourethane formed by a method described herein.

In some embodiments, the recycled thermoset polycarbonate or recycled thermoset polythiourethane is configured to be reprocessed without addition of additional catalyst and without loss in mechanical properties.

Other embodiments relate to a recyclable thermoset polycarbonate that includes a mechanochemically vitrimerized polycarbonate. The mechanochemically vitrimerized polycarbonate can include a dynamic recyclable network in which a portion of a zinc-based catalyst complexes carbonate groups of the polycarbonate in the presence of a hydroxyl providing agent.

Still other embodiments relate to a recyclable polythiourethane that includes a mechanochemically vitrimerized polythiourethane. The mechanochemically vitrimerized polythiourethane can include a dynamic recyclable network in which a portion of a zinc-based catalyst complexes thiourethane groups of the polythiourethane in the presence of a hydroxyl providing agent.

### BRIEF DESCRIPTION OF THE DRAWINGS

FIG. 1. is a schematic of PADC and PTU vitrimerization process by mechanochemical approach.

FIGS. 2(A-B) illustrate FTIR spectra of the initial thermoset, cryomilled powder mixture, and vitrimerized PADC (A) and PTU (B). Samples compositions are shown in Table 1.

FIGS. 3(A-B) illustrate stress relaxation curves for PADC (A), and PTU (B) samples at different temperatures; on the vertical axis, the modulus (G(t)) was normalized by the initial modulus (G0). The dashed lines represent the fitted curves utilizing the KWW equation.

FIG. 4 illustrates plots of the relaxation time as a function of the inverse temperature. The dashed lines illustrate the linear fit connecting the experimental data points using the Arrhenius equation. R² signifies the coefficient of determination for the fitting.

FIGS. 5(A-B) are schematic mechanisms for the carbonate exchange reaction in PADC (A) and thiourethane exchange reaction in PTU (B). R—O—H represents the OH feedstock (DPE). Color of puzzles are matched with the color of elements in chemical equations.

FIGS. 6(A-B) DMA curves of PADC (A) and PTU (B) samples. The solid lines represent storage modulus (E′) and the dashed lines represent the loss factor (tan δ).

FIGS. 7(A-B) illustrate stress—Strain curves of PADC (A) and PTU (B) samples.

FIGS. 8(A-B) illustrate DSC thermograms (2^{nd} heating) of PADC (A) and PTU (B) samples.

FIGS. 9(A-B) illustrate TGA curves of PADC (A) and PTU (B) samples. T5 represents the temperature at which a material loses 5% of its initial weight. This parameter is often used to characterize the thermal stability.

### DETAILED DESCRIPTION

For convenience, certain terms employed in the specification, examples, and appended claims are collected here. Unless defined otherwise, all technical and scientific terms used herein have the same meaning as commonly understood by one of ordinary skill in the art to which this application belongs.

The articles “a” and “an” are used herein to refer to one or to more than one (i.e., to at least one) of the grammatical object of the article. By way of example, “an element” means one element or more than one element.

The terms “comprise,” “comprising,” “include,” “including,” “have,” and “having” are used in the inclusive, open sense, meaning that additional elements may be included. The terms “such as”, “e.g.,”, as used herein are non-limiting and are for illustrative purposes only. “Including” and “including but not limited to” are used interchangeably.

The term “or” as used herein should be understood to mean “and/or”, unless the context clearly indicates otherwise.

As used herein, the term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length ±15%, ±10%, ±9%, ±8%, ±7%, ±6%, ±5%, ±4%, ±3%, ±2%, or ±1% about a reference quantity, level, value, number, frequency, percentage, dimension, size, amount, weight or length.

As used herein, “one or more of a, b, and c” means a, b, c, ab, ac, be, or abc. The use of “or” herein is the inclusive or.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

This disclosure describes a method of recycling thermosets containing carbonate and/or thiourethane linkages, such as polyallyl diglycol carbonate (PADC) and polythiourethane (PTU), commonly used in commercial applications via a mechanochemical process known as vitrimerization. The method utilizes zinc-based catalysts along with a hydroxyl (OH)-providing agent to make a covalent adaptable network. The results show that the permanent crosslinked structure of the thermoset containing carbonate and/or thiourethane linkages is converted to a dynamic network upon vitrimerization. Rheological tests revealed the remarkable stress-relaxation capabilities of the vitrimerized networks, indicating the conversion of the initial permanent crosslinked structures into dynamic networks through vitrimerization. Dynamic mechanical analysis results show that the vitrimerized samples display a consistent rubbery plateau at high temperature, similar to that of permanently crosslinked networks, suggesting a fixed crosslink density during an exchange reaction. Differential scanning calorimetry and thermogravimetric analysis results showed that the thermal properties of the vitrimerized samples closely resemble those of the original samples. Advantageously, the processing conditions do not require the handling or use of solvents, thereby representing a significant improvement over approaches in which catalysts are dissolved in a solution so as to induce swelling of the thermoset and expedite the overall recycling process.

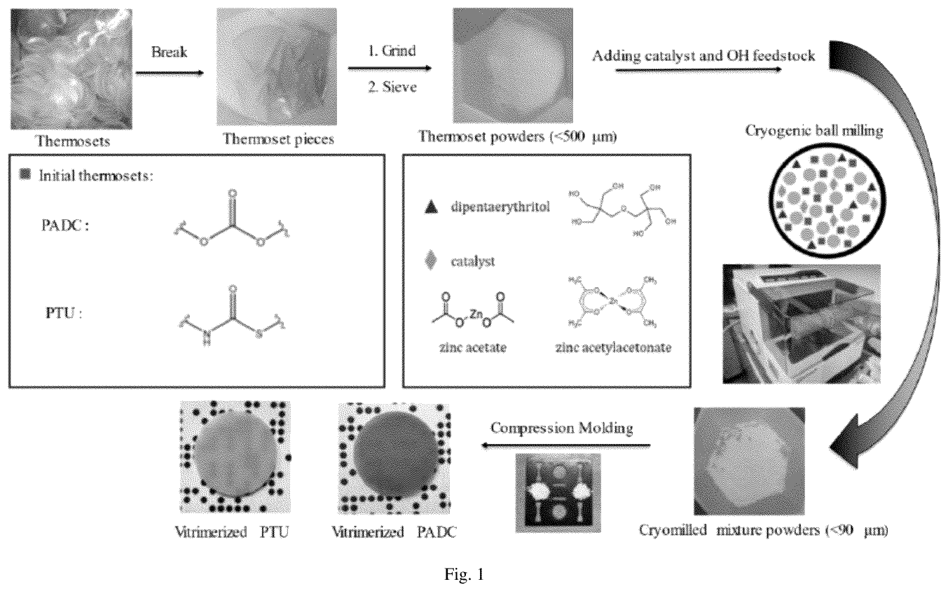

FIG. 1 illustrates a schematic of a method for recycling thermosets containing carbonate and/or thiourethane linkages, such as PADC and PTU, by vitrimerization. The thermosets containing carbonate and/or thiourethane linkages are first fragmented and finely ground into powders in a milling device, such as rotating drum or other milling device. The finely ground powders of the thermosets can have an average particle size less than about 1 mm, less than about 900 μm, less than about 800 μm, less than about 700 μm, less than about 600 μm, or less than about 500 μm. The thermoset provided in a smaller size, such as lees than about 1 mn, diminishes the need of thermal stimuli and enables or facilitates vitrimerization.

The finely ground powder of the thermoset containing carbonate and/or thiourethane linkages can then be mixed with a zinc-based vitrimerization catalyst and a OH-providing agent. We found that both the zinc-based catalyst and the additional OH-providing agent are essential for the vitrimerization of the thermoset containing carbonate and/or thiourethane linkages. In other words, both the zinc-based catalyst and additional OH-providing agent are required to be simultaneously present to achieve vitrimerization of the thermoset containing carbonate and/or thiourethane linkages.

The zinc-based catalyst can be chosen based on the chemistry of the thermoset. The catalyst should be chosen such as to have a sufficiently high degradation temperature to minimize deactivation/loss of the material under the expected milling conditions. In some embodiments, the zinc-based catalyst can include zinc(II)acetate (Zn(OAc)A). In other embodiments, the zinc-based catalyst can include zinc acetylacetonate (Zn(AcAc)₂). Still other examples of zinc-based catalysts can include zinc octoate (Zn(Oct)₂) and zinc neodecanoate (Zn(neo)₂).

The zinc-based catalyst can mixed with the OH-providing agent and the thermoset at an amount effective to produce a vitrimer having desired properties. Specific, non-limiting amounts of the zinc-based catalyst that have been found effective include about 2 parts per hundred of resin (phr) to about 15 phr of the thermoset. In some embodiments, the mixture to be milled (i.e., thermoset, catalyst, OH-providing agent combined) can include about 1 wt. % to about 15 wt. % of the zinc-based catalyst. In other embodiments, the zinc-based catalyst may be provided at less than about 8.0 wt. %, less than about 9.0 wt. %, less than about 10.0 wt. %, or less than about 15 wt. % and any range of values bounded by these upper and lower limits. For example, the zinc-based catalyst can be provided at about 1 wt. % to less than about 15 wt. %, about 1 wt. % to about 14 wt. %, about 1 wt. % to about 13 wt. %, about 1 wt. % to about 12 wt. %, about 1 wt. % to about 11 wt. %, about 1 wt. % to about 10 wt. %, about 2 wt. % to about 14 wt. %, about 3 wt. % to about 14 wt. %, about 4 wt. % to about 14 wt. %, about 5 wt. % to about 14 wt. %, about 3 wt. % to about 13 wt. %, about 4 wt. % to about 12 wt. %, or about 5 wt. % to about 10 wt. % of the mixture. Advantageously, the amount of zinc-based catalyst should be minimized or at least selected to balance against processing times and costs (as the catalyst may be more expensive to procure than the thermoset material).

The hydroxyl (OH)-providing agent can include any carbon-based molecule with at least one hydroxyl group that can serve as a nucleophile for bond exchange reactions. It was determined that adding excess of external hydroxyl group (e.g., polyols such as dipentaerythritol) in the thermoset matrix can inhibit the formation of zinc carboxylate complexes during ball milling. Without wishing to be bound by theory, zinc carboxylate complexes created through vitrimerization act as physical crosslinking junctions and increasing the catalyst amount (i.e., increasing zinc carboxylate complexes) results in higher crosslinking density and storage modulus. Excess addition of external hydroxyl groups may inhibit the formation of zinc carboxylate complexes, and consequently reduce the crosslinking density.

The OH-providing agent can be provided in solid and/or powdered form. In some embodiments, the OH-providing agent can include a polyol, which contains multiple hydroxyl groups attached at various points along the carbon-base. Such polyols may be straight-chained, branched or cyclic. Examples, OH-providing polyols include glycerol, trimethylolpropane, pentaerythritol, dipentaerythritol, tripentaerythritol, 1,4-butanediol, ethylene glycol, neopentyl glycol, and sorbitol. In other embodiments, the OH-providing agent is a polyol, such as pentaerythritol, dipentaerylthritol, or tripentaerythritol. Preferably, the OH-providing agent is dipentaerythritol.

The OH-providing agent can mixed with the zinc-based catalyst and the thermoset at an amount effective to produce a vitrimer having desired properties. Specific, non-limiting amounts of the OH-providing agent that have been found effective include about 5 part per hundred of resin (phr) to about 15 phr of the thermoset. In some embodiments, the mixture to be milled (i.e., thermoset, catalyst, OH-providing agent combined) can include about 5 wt. % to about 15 wt. % of the OH-providing agent. In other embodiments, the OH-providing agent may be provided at less than 8.0 wt. %, less than 9.0 wt. %, less than 10.0 wt. %, or less than about 15 wt. % and any range of values bounded by these upper and lower limits. For example, the OH-providing agent can be provided at about 5 wt. % to less than 15 wt. %, about 5 wt. % to about 14 wt. %, about 5 wt. % to about 13 wt. %, about 5 wt. % to about 12 wt. %, about 5 wt. % to about 11 wt. %, about 5 wt. % to about 10 wt. %, about 6 wt. % to about 14 wt. %, about 7 wt. % to about 14 wt. %, about 8 wt. % to about 14 wt. %, about 9 wt. % to about 14 wt. %, about 10 wt. % to about 13 wt. %, or about 10 wt. % to about 12 wt. % of the mixture.

The mixture of the thermoset, zinc-based catalyst, and OH-providing agent can then be introduced in a cryogenic mill and cryomilled at cryogenic temperatures (e.g., below 150° C.) to produce a finely ground powder with substantially uniform particle size. It was found that milling the mixture at a low temperature, such as a temperature below −150° C. would lead to recycled materials with better quality. Unlike the prior art milling at a high temperature around 300° C., milling at a low temperature may avoid excessive heat attributes to the thermal stress and unwanted reactions and other property changes. By action of the milling, the zinc-based catalyst becomes intimately mixed with the particles of thermoset material and the OH-providing agent. In some embodiments, milling of the mixture is conducted at a temperature range of below about −150° C.; preferably below about −190° C.; more preferably below about −190° C. to about −200° C. It was surprisingly found that by milling the thermoset at an extremely low temperature, little thermal stress is given, thereby leading to enhanced quality of the recyclable thermoset material.

The cryogenic mill can include a rotating drum with steel balls and/or other appropriate media. The rotational movement ensures that the milling media is intimately mixed with rigid cryogenic thermoset, zinc-based catalyst, and OH-providing agent. The rotation both promotes mixing and, owing to the collisions between particles, particulates, and/or the milling media, crushes and reduces the size of the particulates and forms metal-polymeric ligand sites. While a rotating drum is schematically illustrated, any conventional milling apparatus may suffice including jaw crusher, rotor mill, cutting mill, knife mill, mortar grinder, disc mill and ball mill. Optionally, the steel balls may be replaced or augmented by other common milling media (provided that the milling media itself does not disintegrate or otherwise introduce unwanted materials). The milling media must be sufficiently durable to grind and pulverize the particles and particulates and impart the energy required to form the metal-polymeric ligand sites.

By way of example, the mixture of the thermoset, zinc-based catalyst, and OH-providing agent can be cryomilled at −196° C. for a total time of 47 minutes. The cryomilling process included three cryo cycles lasting 15 minutes each at a frequency of 30 Hz, as well as two intermediate cycles lasting 1 minute each at a frequency of 5 Hz.

By action of the milling, the zinc-based catalyst and OH-providing agent become intimately mixed with the small pieces of thermoset and form a fine powder where a portion of the zinc-based catalyst complexes carbonate groups and/or thiourethane groups of the thermoset. Fine powder will be understood to describe the comparative particle size. Powder is significantly smaller in average particle size and distribution in comparison to grinding. Both techniques are known in the art.

The finely ground powder of thermosets, zinc-based catalyst, and OH-providing agent can have an average particle size less than about 100 μm, less than about 90 μm, less than about 80 μm, less than about 70 μm, or less than about 60 μm.

The cryomilled finely ground powder of thermosets, zinc-based catalyst, and OH-providing agent is thermally processed to a create a dynamic recyclable network in which a portion of the zinc-based catalyst complexes carbonate groups of the polycarbonate or thiourethane groups of the polythiourethane and prepare the vitrimerized thermoset. The thermal processing can include compression molding the cryomilled finely ground powder to form the vitrimerized thermoset.

The compression molding can be performed above the glass transition temperature (softening temperature) of materials in the vitrimerized thermoset composition but low enough to not have degradation. Degradation can be detected by either color measurements, IR spectroscopy or thermogravimetric analysis.

In some embodiments, the compression molding can include heating the cryomilled finely ground powder at a temperature of about 170° C. to about 200° C. and at a pressure of about 1 MPa to about 10 MPa. By way of example, the cryomilled powder mixtures can be compression molded using a Hydraulic Lab Press (Carver, Inc.). The molding temperature can be about 190° C. for PADC samples, and about 175° C. for PTU samples. The molding process can include a preheating period of 15 minutes, followed by 60 minutes of pressing under a force of 5000 pounds.

The vitrimer thermoset containing the carbonate and/or thiourethane linkages can be reprocessed by heating the vitrimer thermoset at a temperature below the melting temperature of the catalyst. For example, the vitrimer thermoset can be reprocessed by compression molding the vitrimer polythiourethane or vitrimer polycarbonate at a temperature below the melting temperature of the catalyst.

The vitrimerized thermoset can exhibit stress relaxation at a temperature range of about 150° C. to about 190° C. The stress relaxation indicates a shift from the permanent crosslinked structure of the initial thermoset to a dynamic covalent network following the vitrimerization process.

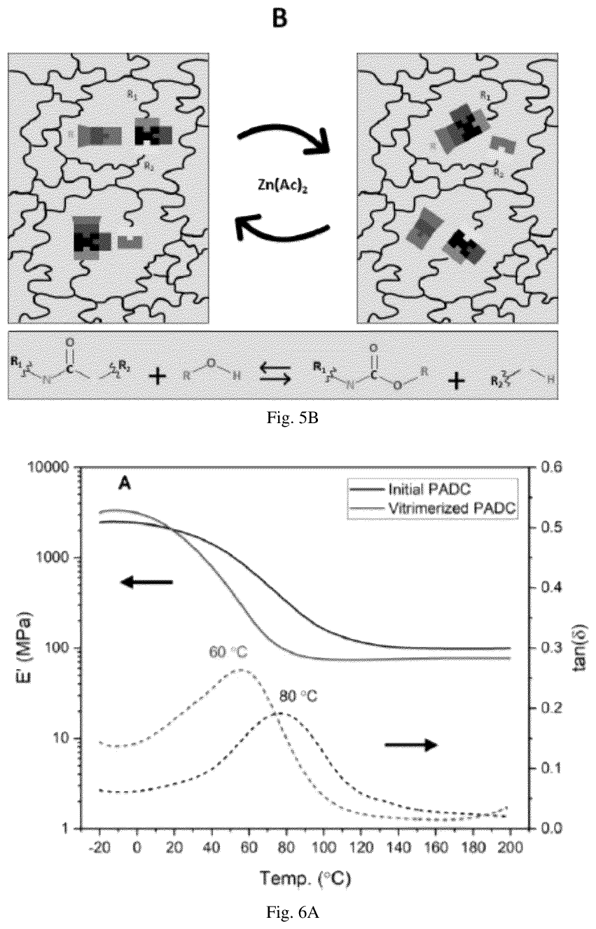

FIG. 5 shows schematic mechanisms for the carbonate exchange reaction in PADC and thiourethane exchange reaction in PTU. R—O—H represents the OH feedstock (DPE). The Ea values were 171 kJ/mol for PADC, and 117 kJ/mol for PTU samples. This outcome suggests that the activation energy is influenced by both the nature of the exchange reaction and the catalyst employed. Based on the literature, these activation energies are well in line with the carbonate and thiourethane exchange reactions which occur during the vitrimerization process of a PADC and a PTU, respectively.

Once the vitrimer-type polymer is formed, it can be reprocessed and recycled without adding more catalyst. Dynamic analysis, including the data below, indicates the vitrimer-type polymer exhibits comparable characteristics to the original/“virgin” thermoset polycarbonate or polythiourethane. In some embodiments, vitrimer polycarbonate or polythiourethane or an article that includes the vitrimer polycarbonate or polythiourethane can have at least one of a Young's modulus (GPa) greater than the thermoset polycarbonate or polythiourethane, a tensile strength (MPa) greater than the thermoset polycarbonate or polythiourethane, or an elongation at break (%) less than the thermoset polycarbonate or polythiourethane.

Advantages of the disclosed method include the elimination of any solvents. Further, ball milling can be achieved at low temperatures. Milling operations can be engineered to incorporate batch or continuous feed processes, with the latter requiring material feed rates to be controlled in combination with the milling conditions to ensure sufficient resident time is achieved in the mill, with gravity-induced inclines, rotation of the milling chamber, and/or release valves providing further measures of control.

Still other embodiments relate to a recyclable thermoset that includes a mechanochemically vitrimerized polythiourethane or polycarbonate that includes a dynamic recyclable network in which a portion of a catalyst complexes thiourethane groups of the polythiourethane, urethane groups of the polyurethane, and/or carbonate groups of the polycarbonate in the presence of a hydroxyl providing agent.

### EXAMPLE

This Example explores the vitrimerization of PADC and PTU thermosets that are commonly available in the market. We used Zn catalysts and Dipentaerythritol (DPE) as hydroxyl (OH) group provider for the exchange reaction. Infrared spectroscopy (FTIR) confirms the formation of zinc complexes with the carbonyl species of carbonate groups within PADC and the thiourethane groups within PTU during the ball milling process. Furthermore, stress relaxation tests indicate the conversion of thermosets into vitrimers through vitrimerization. The thermomechanical properties of the vitrimerized samples were investigated and compared with those of the initial samples by DMA, TGA and DSC techniques.

### Materials and Methods

### Materials

Commercially available PADC and PTU thermoset were used in this study. Dipentaerythritol (DPE), Zinc acetate (Zn(Ac)₂) and Zinc acetylacetonate (Zn(AcAc)₂) were purchased from Sigma-Aldrich. All chemicals were used as received without further purification.

### Vitrimerization Process

The vitrimerization process is shown schematically in FIG. 1. The initial PADC and PTU thermosets were fragmented and subsequently finely ground into powders with a size of less than 500 μm. They were blended with DPE and zinc catalyst at specified concentrations as summarized in Table 1. These mixtures were introduced into a cryogenic ball mill jar (Retsch cryomill) and purged with nitrogen gas prior to the cryomilling process. Subsequently, they were cryomilled at −196° C. for a total time of 47 minutes. The cryomilling process included three cryo cycles lasting 15 minutes each at a frequency of 30 Hz, as well as two intermediate cycles lasting 1 minute each at a frequency of 5 Hz. To prepare the vitrimerized samples, the cryomilled powder mixtures were compression molded by using a Hydraulic Lab Press (Carver, Inc.). The molding temperature was 190° C. for PADC samples, and 175° C. for PTU samples. The molding process included a preheating period of 15 minutes, followed by 60 minutes of pressing under a force of 5000 pounds. It is important to emphasize that cryomilling initial thermosets alone or in combination with either the zinc catalyst or OH feedstock, did not result in vitrimer formation. This underscores the necessity of having both the catalyst and OH feedstock present simultaneously to achieve vitrimerization.

TABLE 1
Sample formulation

| | Composition (phr) | | | | |
|---|---|---|---|---|---|
| Sample | PADC | PTU | Zn(AcAc)₂ | Zn(Ac)₂ | DPE |
| Vitrimerized PADC | 100 | 0 | 5 | 0 | 10 |
| Vitrimerized PTU | 0 | 100 | 0 | 5 | 10 |

### Characterization

FTIR analysis was conducted using an Agilent Cary 630 FTIR spectrometer equipped with a Germanium (Ge) attenuated total reflectance (ATR) cell. The scanning range was set from 4000 to 600 cm⁻¹, with a resolution of 2 cm⁻¹. Each spectrum was obtained by averaging 32 scans. FTIR spectra of PADC were normalized using the peak at approximately 1455 cm⁻¹, which corresponds to the C—H bending in methylene groups. FTIR spectra of PTU were normalized using the peak at approximately 1414 cm⁻¹, which corresponds to the aromatic C—C stretching mode. Stress relaxation experiments were conducted using a TA ARES-G2 rheometer equipped with a 25 mm parallel plate geometry. The disk samples had an average thickness of 1.2 mm and were allowed to equilibrate at the desired temperature for 10 minutes prior the testing. A step strain of 1% was applied to the samples, while a constant normal force of ION was simultaneously applied to prevent any separation between the sample and the plate during the testing. Thermal stability was studied by using a TA Instruments Q500 instrument. For each run, 5-8 mg sample was put in a platinum pan. Samples were equilibrated at 50° C. and heated to 600° C. with a heating rate of 10° C./min under a constant nitrogen flow. DSC tests were conducted using a TA Instruments DSC Q2000 Instrument under a constant nitrogen flow rate of 50 ml/min. 8-10 mg sample was placed in an aluminum pan sealed with an aluminum cap. The heat-cool-heat program was done up to 200° C. at the rate of 10° C./min to remove the thermal history. The second heating cycle was done from −20 to 200° C. DMA tests were carried out using a TA Instruments Q800. The testing was done under tension mode, with a strain amplitude of 0.05% and a constant frequency of 1 Hz. The temperature ramped up at a scanning rate of 5° C./min, ranging from −20 to 200° C.

Uniaxial tensile tests were carried out at room temperature using an Instron 5965 universal testing machine equipped with load cell of 1 kN at an extension rate of 1 mm/min. Dumbbell-shaped test specimens were prepared with dimensions according to ASTM D1708.

### Results and Discussion

### FTIR Analysis

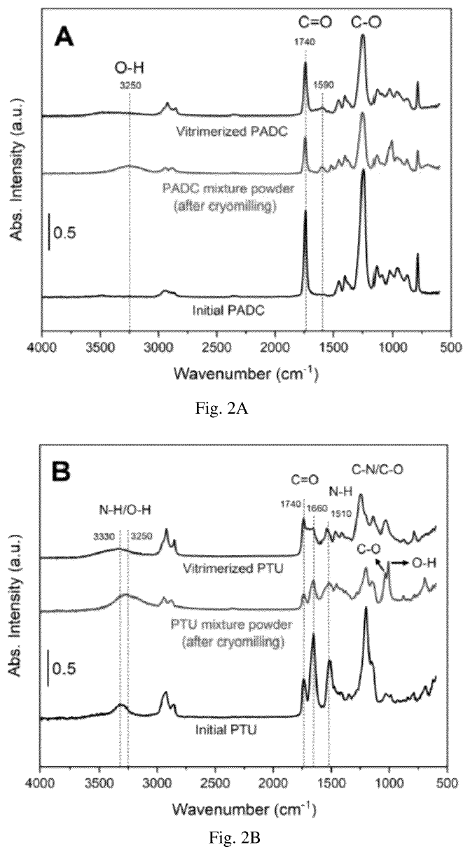

ATR-FTIR spectroscopy was employed to confirm the chemical structures of initial and vitrimerized samples. FIG. 2 illustrates the IR spectra of the initial PADC and PTU thermosets, their mixture powder (after cryomilling) including OH feedstock (DPE) and Zinc catalyst, and the vitrimerized samples. The IR spectrum of initial PADC (FIG. 2A) shows characteristic peaks at 2950 and 2860 cm⁻¹ (asymmetric and symmetric C—H stretching), 1740 cm⁻¹ (C═O stretching, carbonate), 1000-1300 cm⁻¹ (C—O stretching, carbonate and ether). The IR spectrum of initial PADC does not exhibit a peak associated with hydroxyl groups (3200 to 3600 cm⁻¹), suggesting the requirement to introduce a hydroxyl group source using DPE. A broad peak centered at 3250 cm⁻¹ and a peak centered at 1590 cm⁻¹ emerged for PADC mixture powder after cryomilling as a result of adding DPE and Zn(AcAc)₂. The peak at 1590 cm⁻¹ could indicate the formation of a complex between Zn²⁺ and the carbonyl (C═O) species of the carbonate functional groups throughout the PADC network after the cryomilling step. The dynamic crosslinks are introduced across the structure during compression molding of the cryomilled powders enabling a carbonate exchange reaction. This reaction occurs between the carbonate-zinc complexes and the free hydroxyl groups present in the system. As a result, the intensity of the OH band diminishes in IR spectrum of vitrimerized PADC, suggesting their involvement in the exchange reaction that generates a dynamic network.

The IR spectrum of initial PTU thermoset (FIG. 2B) shows characteristic peaks at 2950 and 2860 cm⁻¹ (asymmetric and symmetric C—H stretching), 3330 and 1510 cm⁻¹ (N—H stretching and bending), 1660 and 1740 cm⁻¹ (C═O stretching, thiourethane and ester), 1000-1300 cm⁻¹ (C—N symmetric vibration and C—O stretching). Notably, the unsuccessful vitrimerization of PTU solely through the addition of Zn(Ac)₂ (without DPE as a hydroxyl source) suggested that the peak at 3330 cm⁻¹ can be attributed to the N—H bond rather than the hydroxyl groups. The IR spectrum of the PTU mixture powder (after cryomilling) exhibits a new broad peak centered at 3250 cm⁻¹ associated with OH and NH stretching from DPE and thiourethane groups. Additionally, a doublet peak emerged at 1010 and 1040 cm⁻¹, likely corresponding to the bending vibrations of OH (alcohol) and the stretching of the CO (ether) in DPE³⁰. Notably, detecting the peak associated with Zn²⁺/carbonyl complexes was challenging due to overlapping signals and a busy spectral region ranging from 1500 to 1700 cm⁻¹. The reduction in the intensity of the OH band within the IR spectrum of the vitrimerized PTU, ranging from 3000 to 3500 cm⁻¹, coupled with the transformation of the doublet peak into a singular peak, within the range of 1000 to 1100 cm⁻¹ (transitioning from the red to the blue curve), suggests the involvement of the hydroxyl groups in the exchange reaction that contributes to the formation of a dynamic network.

### Stress-Relaxation Analysis

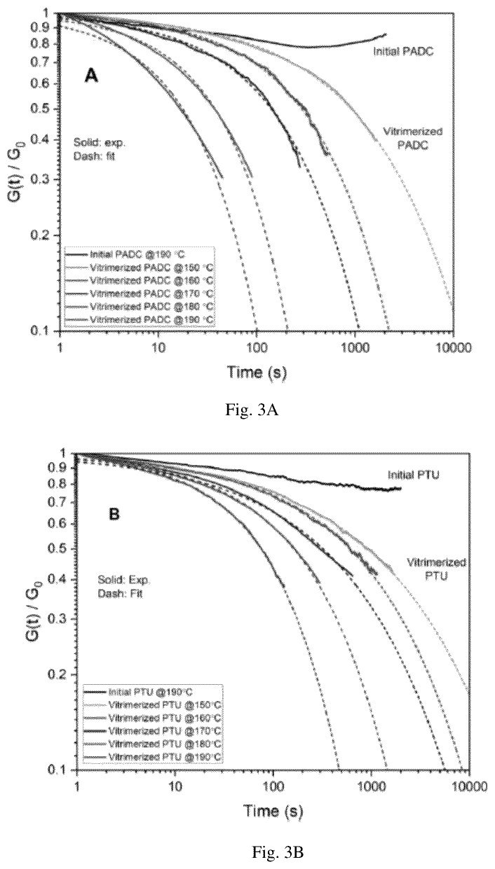

To validate the formation of a vitrimer network, stress relaxation data were acquired for each of the vitrimerized networks (FIG. 3). Characteristic of a vitrimer network, exchange reactions become active at elevated temperatures, leading to topology rearrangements and stress relaxation. As shown in FIG. 3, the vitrimerized PADC and PTU samples exhibited stress relaxation at different testing temperatures ranging from 150 to 190° C. On the contrary, the initial PADC and PTU samples did not show stress relaxation, even when tested at the highest temperature of 190° C. This indicates a shift from the permanent crosslinked structure of the initial thermoset to a dynamic covalent network following the vitrimerization process. Regarding the quantitative analysis of the relaxation behavior, the stress relaxation curves were subjected to fitting using the Kohlrausch-Williams-Watts (KWW) function, as follow:

$$\frac{G ( t )}{{G}_{0}} = exp \{ - {( \frac{t}{t} )}^{β} \} \qquad ( 1 )$$

This allowed for the determination of the characteristic relaxation time (τ) and the relaxation time distribution (β); G(t)/G0 is the normalized shear modulus. The basic Maxwell equation can be obtained under the assumption of β=1, indicating a single relaxation time. However, more complex vitrimer systems can exhibit a distribution of relaxation times (β<1).

Previous studies demonstrated that the application of the KWW model was suitable for characterizing the relaxation behavior of vitrimer systems. The experimental relaxation curves of the vitrimerized samples in this study can be well fitted with the KWW model, and the adjusted fitting parameters of τ and β are summarized in Table 2.

TABLE 2
Fitting Parameters for Stress Relaxation Curves

| | | |
|---|---|---|
| Temp. | Vitrimerized PADC | Vitrimerized PTU |

| (° C.) | τ (s) | β | R² | τ (s) | β | R² |
|---|---|---|---|---|---|---|
| 150 | 1990 | 0.48 | 0.996 | 2370 | 0.39 | 0.998 |
| 160 | 538 | 0.59 | 0.997 | 1357 | 0.46 | 0.996 |
| 170 | 265 | 0.58 | 0.994 | 772 | 0.42 | 0.993 |
| 180 | 64 | 0.70 | 0.990 | 317 | 0.55 | 0.994 |
| 190 | 30 | 0.69 | 0.984 | 132 | 0.65 | 0.996 |

R² represents the fitting coefficient of determination.

The temperature-responsive characteristics of the vitrimerized structure arise from the dynamic covalent bonds within the network. The viscosity is regulated by chemical exchange reactions. This controlled viscosity enabled by exchange reactions ensures that the vitrimers can undergo processing without compromising the integrity of the network. The Arrhenius equation is utilized to plot the characteristic relaxation times for the bond exchange reaction at different temperatures This equation is represented as follows:

$$τ = {τ}_{0} exp ( - \frac{{E}_{a}}{RT} ) \qquad ( 2 )$$

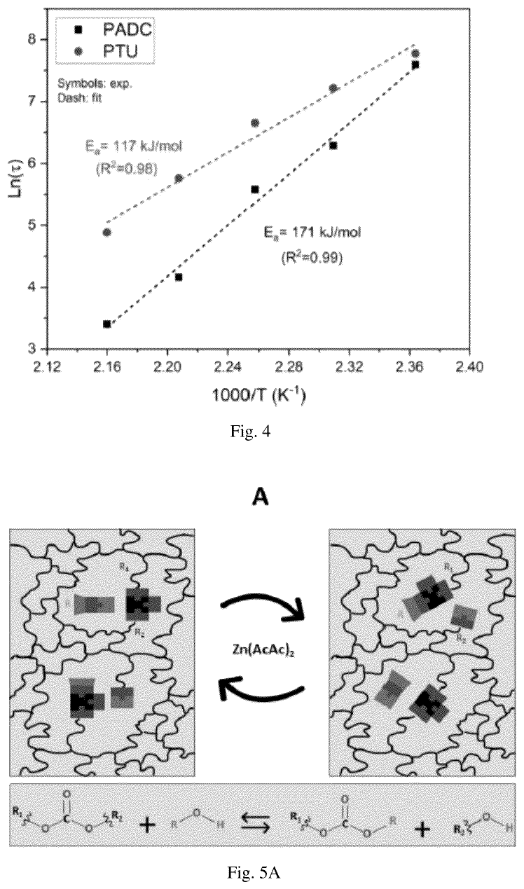

The plot presented in FIG. 4 shows (τ) as a function of the inverse temperatures of the five samples. The slope of the logarithmic Arrhenius equation was used to determine the activation energy (Ea) for the bond exchange reaction. The Ea values were 171 kJ/mol for PADC, and 117 kJ/mol for PTU samples. This outcome suggests that the activation energy is influenced by both the nature of the exchange reaction and the catalyst employed. Based on the literature, these activation energies are well in line with the carbonate and thiourethane exchange reactions which occur during the vitrimerization process of a PADC and a PTU, respectively. FIG. 5 illustrates a simple schematic of the proposed mechanisms for these exchange reactions. However, additional investigations are necessary to uncover the precise mechanisms at molecular level.

### Thermomechanical Analysis

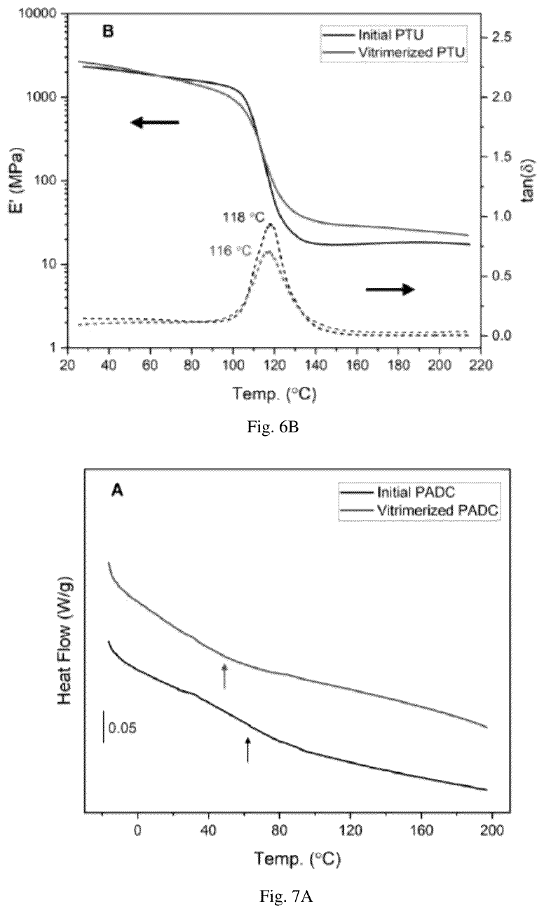

The mechanical properties and thermal behavior of the vitrimerized samples was investigated and compared with the initial thermosets by DMA, Tensile, DSC and TGA techniques. FIG. 6 shows the changing of the storage modulus (E′) and the loss factor (tan δ) as a function of temperature. Upon heating from the glassy state, a decrease in storage modulus, along with the appearance of the relaxation peak (glassy to rubbery transition) in tan δ was observed. A slight shift in the glass transition temperature of the vitrimerized PADC was detected (FIG. 6A). DMA results indicate that the vitrimerized samples exhibit the elastic characteristics of crosslinked networks, as signified by the presence of a rubbery plateau at elevated temperatures. This stable rubbery plateau, characterized by a nearly constant modulus, demonstrates a fixed crosslink density.

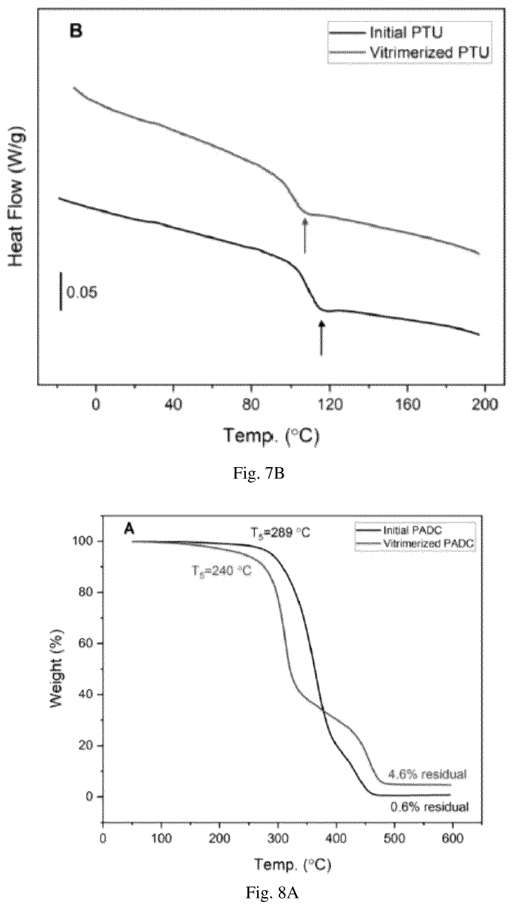

The stress-strain curves and tensile properties of the initial and vitrimerized samples are displayed in FIG. 7 and Table 3. Results indicate that after recycling, around 75% of the maximum tensile strength of the initial thermosets was recovered. The presence of excess alcohol (DPE) in the system may contribute to the dynamic network heterogeneity and may result in limited decrease in mechanical properties.

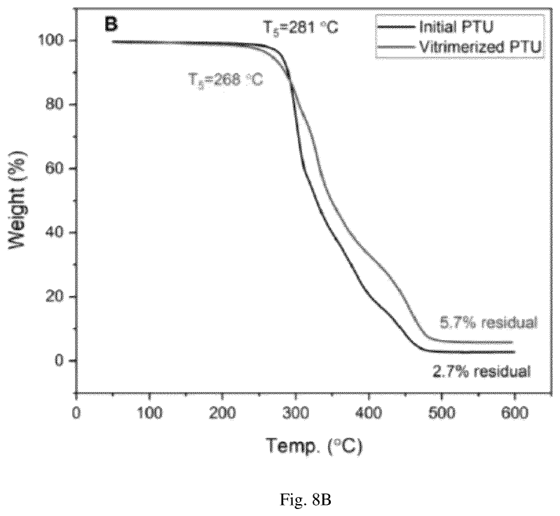

Furthermore, as shown in FIG. 8, the DSC results revealed that the thermal properties of vitrimerized samples closely resemble those of the original thermosets. In the case of the PADC (FIG. 8A), a thermal event was observed within the temperature range of 40-80° C. For the PTU (FIG. 8B), a thermal transition occurred within the temperature range of 100-120° C. These transitions are associated with the shift from glassy to rubbery state and they align with the previously obtained DMA results. The absence of any additional thermal transitions beyond the glass transition temperature for the vitrimerized samples suggests that these samples maintain their amorphous nature, mirroring that of the original thermosets.

TABLE 3
Mechanical properties of initial and vitrimerized samples

| | Young's modulus | Tensile Strength | Elongation |
|---|---|---|---|
| Sample | [GPa] | [MPa] | at break [%] |
| Initial PADC | 1.04 ± 0.03 | 26.6 ± 1.6 | 3.7 ± 0.3 |
| Vitrimerized PADC | 0.73 ± 0.02 | 20.3 ± 1.2 | 3.9 ± 0.2 |
| Initial PTU | 1.20 ± 0.11 | 71.7 ± 1.9 | 12.1 ± 0.8 |
| Vitrimerized PTU | 1.17 ± 0.08 | 54.0 ± 2.5 | 9.9 ± 0.7 |

Finally, the TGA results reveal that the vitrimerized samples exhibit stability even at elevated temperatures, specifically up to 240° C. for the vitrimerized PADC and 270° C. for the vitrimerized PTU (FIG. 9). The thermal decomposition temperature (i.e., 5% weight loss temperature) of the vitrimerized samples is well above the vitrimerization temperature and comparable with the initial thermosets. This makes them suitable for a wide range of applications. In the case of PADC samples, both initial and vitrimerized samples show a two-stage degradation process. The first stage is related to the decomposition of carbonate groups (˜320° C.) and the second stage is attributed to the degradation of the C—C bonds in the polymer backbone (˜450° C.). The initial and vitrimerized PTU samples experience a three-stage degradation, which includes the decomposition of thiourethane groups (˜300° C.), the β-elimination of the ester groups in thiol units (˜350° C.), and the degradation of C—C bonds in polymer backbone (˜450° C.). The higher residual weight in the vitrimerized samples compared to the initial thermosets may be attributed to the presence of the inorganic zinc element in their composition.

Two widely used commercial thermosets (PADC and PTU) can be recycled by employing a mechanochemical process known as vitrimerization. This method utilizes zinc-based catalysts along with an OH-providing agent (DPE), required to make a covalent adaptable network. The stress relaxation results revealed that the vitrimerized networks have the ability to relax stress rapidly, with activation energies measured at 171 kJ/mol for PADC and 117 kJ/mol for PTU. These activation energies are likely associated with carbonate and thiourethane exchange reactions. This study demonstrates the applicability of vitrimerization for the recycling of thermosets containing carbonate and thiourethane linkages.

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

Having described the invention, we claim:

1. A method of recycling a thermoset containing a thiourethane linkage and/or a carbonate linkage, the method comprising:
mechanically mixing the thermoset with a catalyst and a hydroxyl-providing agent such that a portion of the catalyst complexes carbonate groups and/or thiourethane groups of the thermoset; and
optionally thermally processing the mixture to form a recyclable thermoset that includes a dynamic recyclable network.

2. The method of claim 1, wherein the thermoset is provided as particles and/or fragments.

3. The method of claim 2, wherein the thermoset is mechanically ground to provide the particles and/or fragments.

4. The method of claim 1, wherein the catalyst is provided at about 5.0 wt. % to about 15.0 wt. % of the mechanically mixed thermoset.

5. The method of claim 1, wherein the catalyst comprises a zinc-based catalyst.

6. The method of claim 5, wherein the thermoset is a polycarbonate and the zinc-based catalyst is zinc acetylacetonate, or the thermoset is a polythiourethane and the zinc-based catalyst is zinc acetate.

7. The method of claim 1, wherein the hydroxyl-providing agent is a polyol.

8. The method of claim 1, wherein the mixture is mechanically mixed by cryomilling.

9. The method of claim 1, wherein the mixture is thermally processed at a temperature of about 170° C. to about 200° C. and at a pressure of about 1 MPa to about 10 MPa.

10. A method for producing a recyclable polycarbonate or a recyclable polythiourethane, the method comprising:
mechanically mixing a thermoset polycarbonate or a thermoset polythiourethane with a zinc-based catalyst and a hydroxyl-providing agent; and
thermally processing the mixture to form a recyclable vitrimerized polythiourethane or a recyclable vitrimerized polycarbonate that includes a dynamic recyclable network in which a portion of the zinc-based catalyst complexes carbonate groups of the polycarbonate or thiourethane groups of the polythiourethane.

11. The method of claim 10, wherein the thermoset polycarbonate or the thermoset polythiourethane is provided as particles and/or fragments having an average diameter less than about 1 mm.

12. The method of claim 10, wherein the zinc-based catalyst is provided at about 5.0 wt. %, to about 15 wt. % of the mechanically mixed thermoset polycarbonate or thermoset polythiourethane.

13. The method of claim 10, wherein the thermoset polycarbonate is mechanically mixed with zinc acetylacetonate.

14. The method of claim 10, wherein the thermoset polythiourethane is mechanically mixed with zinc acetate.

15. The method of claim 10, wherein the hydroxyl-providing agent is a polyol.

16. The method of claim 10, wherein the mixture is mechanically mixed by cryomilling.

17. The method of claim 10, wherein the mixture is thermally processed at a temperature of about 170° C. to about 200° C. and at a pressure of about 1 MPa to about 10 MPa.

18. The method of claim 10, wherein the recyclable polycarbonate or a recyclable polythiourethane is formed without the use of a solvent.

19. A recycled thermoset polycarbonate or recycled thermoset polythiourethane formed by a method of claim 1.

20. The recycled thermoset polycarbonate or recycled thermoset polythiourethane of claim 19, wherein the recycled thermoset polycarbonate or recycled thermoset polythiourethane is configured to be reprocessed without addition of additional catalyst and without loss in mechanical properties.
